(19) United States
(12) Patent Application Publication
(10) Pub. No.: US 2008/0017455 A1
(43) Pub. Date: Jan. 24, 2008

(54) DRIVE ASSEMBLY WITH OVERRIDE MECHANISM

(75) Inventors: Alan R. Cohn, Lockeford, CA (US); Donald Morris, Conifer, CO (US); David Johnson, Modesto, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: LIFT-U, DIVISION OF HOGAN MFG., INC., Escalon, CA (US)

(21) Appl. No.: 11/615,751

(22) Filed: Dec. 22, 2006

Related U.S. Application Data
(60) Provisional application No. 60/756,338, filed on Jan. 4, 2006.

(51) Int. Cl. B66B 1/34

(52) U.S. Cl. 187/276

(57) ABSTRACT

A drive assembly (100) for a wheelchair lift is provided. The drive assembly (100) includes an actuating assembly (104) in communication with a component of the wheelchair lift. The actuating assembly (104) is configured to selectively apply a driving force to move the component between at least first and second positions. The drive assembly (100) also includes an overload assembly (102) coupled to the actuating assembly (104). The overload assembly (102) is configured to redirect application of the driving force from the component to the overload assembly (102) when a force applied to the component exceeds a predetermined limit.

### CROSS-REFERENCE TO RELATED APPLICATION

This application claims the benefit of U.S. Provisional Application No. 60/756,338, filed Jan. 4, 2006, the disclosure of which is hereby expressly incorporated by reference.

### BACKGROUND

Persons with mobility impairments often depend on a wheelchair or walking aid to facilitate mobility. As a result, they are frequently subjected to physical barriers and obstacles such as stairs and curbs. Current ADA legislation requires that these physical barriers be removed, and as a result, ramps have been designed to address this need. However, ramps can be very long and difficult to climb. Further, depending on the elevation change and available space, ramps may be impractical. One solution is a wheelchair lift. Wheelchair lifts for commercial buildings and private residences must be designed and tested to meet the requirements of the ASME Code: A18.1, SAFETY STANDARD FOR PLATFORM LIFTS AND STAIRWAY CHAIRLIFTS.

The wheelchair lift may include certain actuatable components that act as protective barriers or supports; however, those components must meet certain force requirements defined in the ASME Code. Wheelchair lifts typically incorporate an overload assembly having a control system that utilizes contact switches to sense obstructions encountered by the component. Upon sensing an obstruction, the control system typically either shuts down the actuator, effectively stopping the component, or limits the force of the actuator by a current limit or pressure regulator. The overload assembly may be either active or passive. An active overload assembly uses powered controls to achieve force limits, and a passive type uses regulators to limit forces (such as hydraulic relief valves). An active assembly does not easily allow manual override, and passive systems can overheat.

It is desired to have a reliable overload assembly that limits the force the actuator imposes on the actuatable component without damaging the assembly or the obstruction.

### SUMMARY

A drive assembly for a wheelchair lift is provided. The drive assembly includes an actuating assembly in communication with a component of the wheelchair lift. The actuating assembly is configured to selectively apply a driving force to move the component between at least first and second positions. The drive assembly also includes an overload assembly coupled to the actuating assembly. The overload assembly is configured to redirect application of the driving force from the component to the overload assembly when a force applied to the component exceeds a predetermined limit.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isomeric view of a typical wheelchair lift assembly having a drive assembly constructed in accordance with the present disclosure;

FIG. 2 is an isometric view of a drive assembly for a wheelchair lift constructed in accordance with one embodiment of the present disclosure;

FIG. 3 is a side cross-sectional view of the drive assembly of FIG. 2, taken substantially through Section 3-3;

FIG. 4 is a top planar view of the drive assembly of FIG. 2 in a first overload position;

FIG. 5 is an isometric view of the drive assembly of FIG. 2 coupled to an arm guard;

FIG. 6 is an isometric view of the drive assembly of FIG. 2 coupled to a handrail assembly;

FIG. 7 is a cross-sectional view of the lift assembly of FIG. 1 taken substantially through Section 7-7, wherein the drive assembly of FIG. 2 is coupled to a barrier gate;

FIG. 8 is an isometric view of a drive assembly for a wheelchair lift constructed in accordance with an alternate embodiment of the present disclosure;

FIG. 9A is a front planar view of the drive assembly of FIG. 8 in a first overload position;

FIG. 9B is a front planar view of the drive assembly of FIG. 8 in a second overload position;

FIG. 10 is an isometric view of a drive assembly for a wheelchair lift constructed in accordance with another embodiment of the present disclosure; and

FIG. 11 is a side planar view of a drive assembly for a wheelchair lift constructed in accordance with still yet another embodiment of the present disclosure.

### DETAILED DESCRIPTION OF THE EMBODIMENTS

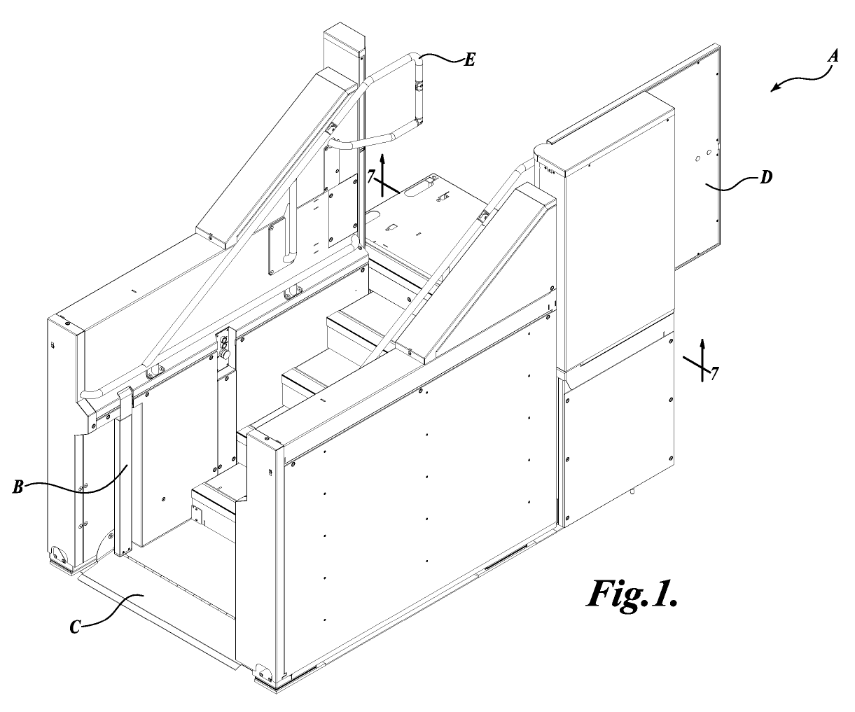

A drive assembly 100 suitable for use with a well-known wheelchair lift A may be best understood by referring to FIGS. 1-4. One such wheelchair lift is disclosed in U.S. Pat. No. 6,601,677, entitled Convertible Lift Mechanism Having a Number of Retractable Stairs with a Lift Platform Positioned Thereunder, the disclosure of which is hereby expressly incorporated by reference. Although one type of wheelchair lift is illustrated, it should be apparent that the scope of the present disclosure is not intended to be so limited.

The wheelchair lift assembly A includes several actuatable components, such as an arm guard B, ramp barrier C, barrier gate D, and handrail extension E. The drive assembly 100 constructed in accordance with one embodiment of the present disclosure includes a frame or base 112, an overload assembly 102, and an actuating assembly 104. The overload assembly 102 includes a bearing assembly, or linear slide 114, coupled to the base 112.

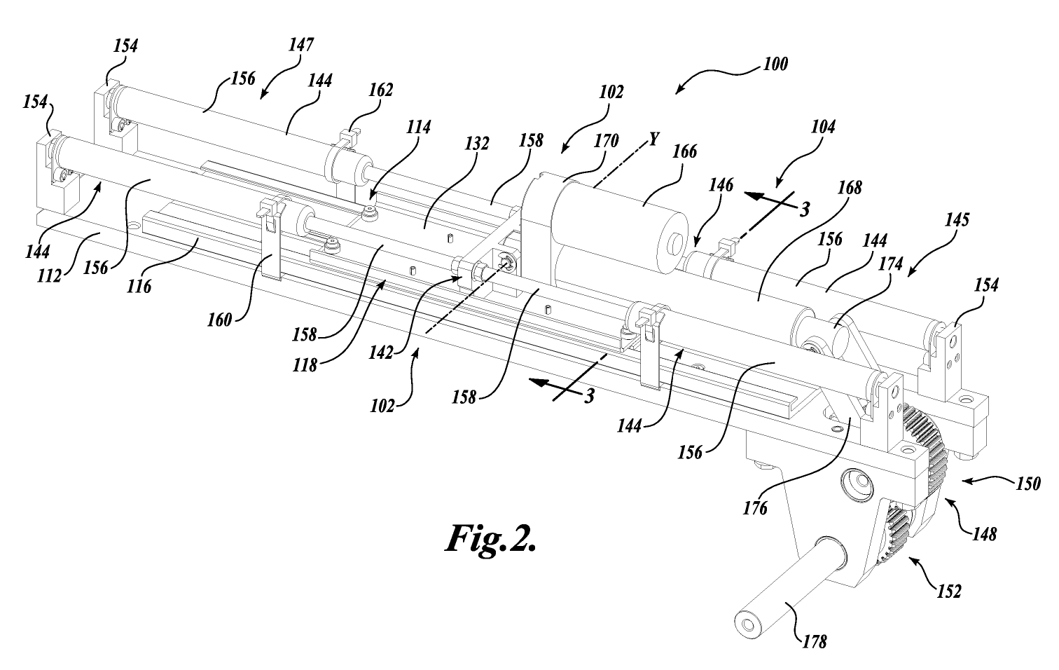

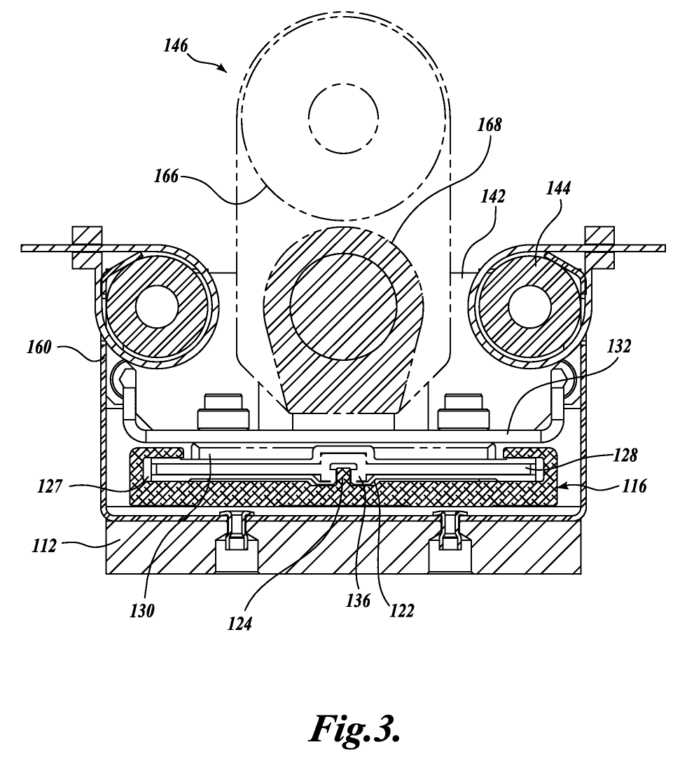

Referring to FIGS. 2 and 3, the linear slide 114 includes a slide rail 116 and a slide bearing assembly 118. The slide rail 116 is fixedly coupled to the base 112 in any suitable manner. The slide rail 116 is C-shaped in cross section to define a receiving channel 127. A longitudinal groove 122 is formed in the bottom of the rail 116 and along the length of the slide rail 116, and a longitudinal notch 124 is formed therewithin.

The receiving channel 127 of the slide rail 116 slidably receives at least a portion of the slide bearing assembly 118. The slide bearing assembly 118 includes a bearing plate 128, an intermediate plate 130, and a mounting plate 132. The bearing plate 128 is sized and shaped to fit within the receiving channel 127. The bottom of the bearing plate 128 includes a longitudinal protrusion 136 that is slidably received within the longitudinal groove 122, and the longitudinal protrusion 136 includes a recess that slidably receives the notch 124.

The mounting plate 132 is positioned above the bearing plate 128 and the intermediate plate 130 is disposed therebetween. The mounting plate 132, intermediate plate 130, and bearing plate 128 are coupled together in any well known manner. In the alternative, the mounting plate 132, intermediate plate 130, and bearing plate 128 may be formed as one piece. A carriage 142 is coupled to the mounting plate 132 in substantially the center of the mounting plate. As shown in FIG. 2, the bearing plate 128, intermediate plate 130, and mounting plate 132 are substantially the same length and are all shorter in length than the slide rail 116 such that the plates 128, 130, and 132 may simultaneously be translated along the slide rail 116 in either linear direction.

Referring back to FIG. 2, the overload assembly 102 further includes at least one override mechanism that helps limit the effects of the driving force delivered to the actuatable component. Preferably, the assembly 102 includes two opposing pairs of gas springs 144, or a first pair of gas springs 145 and a second pair of gas springs 147. Each gas spring 144 is disposed between a mounting device 154 located at a corner of the base 112 and the carriage 142. Although a gas spring is suitable for use as an override mechanism, other types of mechanisms could be used. Examples include, but are not limited to, a pneumatic dampener, a slip clutch, a release valve, or the like.

Each gas spring 144 includes a gas cylinder 156 and a rod 158. A piston (not shown) is coupled to the end of the rod 158, and inert gas stored within the cylinder 156 is compressible by the piston. The gas springs 144 may be any off-the-shelf gas spring with the required preset load, which is determined by the force of the compressed gas on the piston. Gas springs with differing preset loads or with adjustable preset loads are also within the scope of the present disclosure. Moreover, each gas spring 144 has a predetermined stroke length and a predetermined spring rate. Although each gas spring 144 may have different stroke lengths and spring rates, it is preferred that the gas springs 144 of both pairs of gas springs 145 and 147 have substantially equal stroke lengths and spring rates. It should be appreciated by one skilled in the art that other types of springs, such as coil compression springs or extension springs, may also be used, but gas springs 144 are preferable.

The cylinder ends of the gas springs 144 are coupled to the mounting devices 154 in any suitable manner. The gas springs 144 are suspended above the base 112 and linear slide 114 by a support bracket 160 and tie 162. The bracket 160 is fixedly coupled to the base 112 and extends upwardly therefrom to contact the gas cylinder 156. A suitable tie 162 is used to secure the cylinder 156 to the bracket 160. The ends of the rods 158 are receivable within recesses (not shown) formed in the carriage 142. The rod ends of the second pair of gas springs 145 engage one side of the carriage 142, and the rod ends of the first pair of gas springs 147 engage the other side of the carriage 142.

Each gas spring 144 has the appropriate preset load (or is adjustable) so that the rod 158 is in a fully extended position. Accordingly, when all four gas springs 144 are simultaneously coupled to the carriage 142 through the rod tip ends, they maintain the position of the carriage 142 (and therefore the linear slide 114) in a mid or neutral position. If the preset load on any gas spring 144 is overcome, the gas spring 144 will compress. In other words, the rod 158 will retract within the cylinder 156 so that the piston further compresses the inert air. In effect, the load on the gas spring 144 will increase slightly. Thus, if a force exerted on the carriage 142 exceeds the preset load of a pair of gas springs 145 or 147, the pair of gas springs 144 will compress accordingly. Because the rods 158 are originally in a fully extended, preset load condition, the opposing pair of gas springs 144 come out of contact with the carriage 142 and are supported by the mounting device 154 and the bracket 160.

Still referring to FIG. 2, the actuating assembly 104 includes a suitable actuator 146 for selectively applying a driving force to move the actuatable component. The actuator 146 is preferably a linear actuator having an actuator cylinder 168 coupled to an actuator base 170, and a push rod 174 slidably received within the actuator cylinder 168. The stroke length of the push rod 174 is equal to or less than the stroke length of the gas springs 144. The linear actuator 146 is driven by a motor 166 and includes limit switches (not shown) that shut the actuator 146 off in the fully extended and fully retracted positions. The actuator base 170 is mounted to the linear slide 114 through the carriage 142. The linear actuator 146 is preferably pivotally mounted to the carriage 142 such that the linear actuator 146 is rotatable about an axis transverse to the longitudinal axis of the actuator cylinder 168, or axis Y.

The actuating assembly 104 further includes a suitable gear system, linkage, sprocket assembly, or other suitable assembly for transmitting the mechanical power of the actuator 146 to the actuatable component. As shown in FIG. 2, the push rod 174 is coupled to a gear system 148 having first and second gears 150 and 152. The end of the push rod 174 is operably coupled to the first gear 150, which drives the second gear 152 to rotate the drive shaft 178. The drive shaft 178 in turn reciprocates the actuatable component between at least first and second positions. The end of the push rod 174 is preferably pivotally coupled to one end of a pair of gear driving levers 176, which are in turn fixedly coupled to the first gear 150. As the push rod 174 extends and retracts to drive the first gear 150, the gear driving levers 176 allow the push rod 174 to pivot about axis Y.

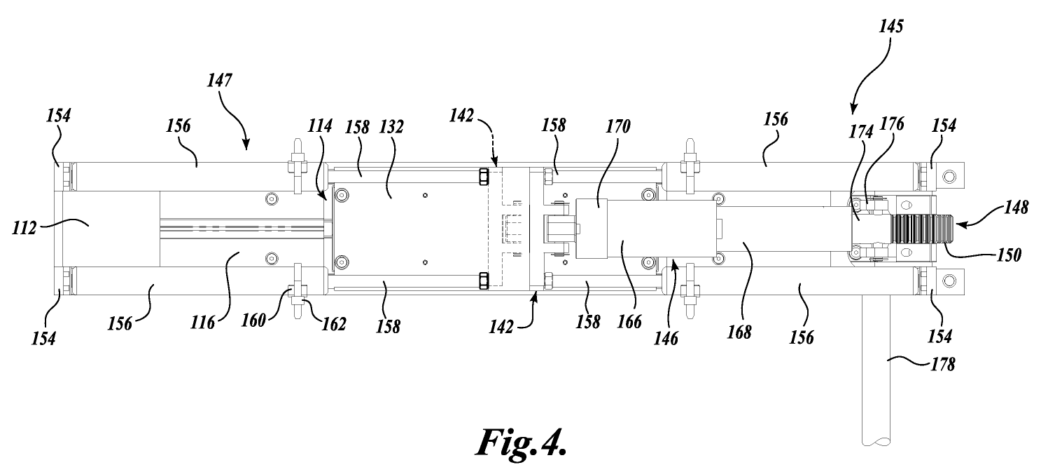

As can best be seen by referring to FIG. 4, the overload assembly 102 limits the driving force of the actuator 146 on the actuatable component by redirecting application of the driving force from the component to the overload assembly 102 when the component encounters an obstruction. In other words, movement of the component is redirected to the overload assembly 102. When the push rod 174 is retracting within the cylinder 168 to move the component, the force from the obstruction causes the component to cease or slow its movement, thereby preventing or slowing the rotation of the gear shaft 178, the gear system 148, and the push rod 174. The actuator 146 continues to retract; however, application of the driving force is redirected and instead pulls the cylinder 168 toward the gear system 148 along the push rod 174. As a result, the carriage 142 is also pulled towards the gear system 148 and applies a force on the rods 158 of the first gas springs 145. Thus, the application of the driving force is redirected to move the gas springs 145 instead of the component.

If the force exceeds the preset load in the first gas springs 145, the first gas springs 145 compress and the carriage 142 and actuator cylinder 168 slide with the mounting plate 132 towards the pair of compressed springs 145. The second pair of gas springs 147 come out of contact with the carriage 142. As the gas springs 145 continue to compress, the driving force on the component is limited by the spring force governed by the spring rate. However, the actuator 146 does not turn off until the push rod 174 is fully retracted and a limit switch (not shown) causes it to shut down. Since the gas spring stroke length is equal to or greater than the stroke length of the linear actuator 146, the linear actuator 146 will stop retracting before the first gas springs 145 fully compress. Thus, damage to the linear actuator 146 is minimized, such as damage from stall torque, high electric current during stall condition, and back-driving during manual operation.

The same is true if the push rod 174 is extending to move the component and the component encounters an obstruction (not shown), causing the push rod 174 to cease or slow its translation. The actuator 146 continues to extend; however, the cylinder 168 is instead pushed away from the gear system 148 along the push rod 174. As a result, the carriage 142 is also pushed away from the gear system 148 and applies a force on the rods 158 of the second gas springs 147.

Once the redirected force exceeds the preset load in the second gas springs 147, the second gas springs 147 compress and the carriage 142 and actuator cylinder 168 slide with the mounting plate 132 towards the compressed pair of second springs 147. The first pair of gas springs 145 comes out of contact with the carriage 142. As the second pair of gas springs 145 continue to compress, the driving force on the component is limited by the spring force governed by the spring rate. The limit switch causes the actuator 146 to shut off when the push rod 174 is fully extended.

The overload assembly 102 allows selective manual override any time the actuatable component is “unlocked,” i.e. not appropriate for use as a guard, handrail, etc. If unlocked, the actuatable component can be moved manually by applying a force to the component. The force is increased until the resultant net force against the gas springs 144 (either the first or second pair of gas springs 145 or 147, depending on the direction of the force) exceeds the preset load. Once the force exceeds the preset load in the springs 144, the gas springs 144 compress and the carriage 142 and actuator 146 slide with the mounting plate 132 towards the pair of compressed springs 144. The opposing pair of gas springs 144 comes out of contact with the carriage 142. The force that can be exerted on the actuatable component is limited by the spring rate of the gas springs 144. Moreover, the manual movement of the actuatable component is limited to the stroke length of the gas springs 144.

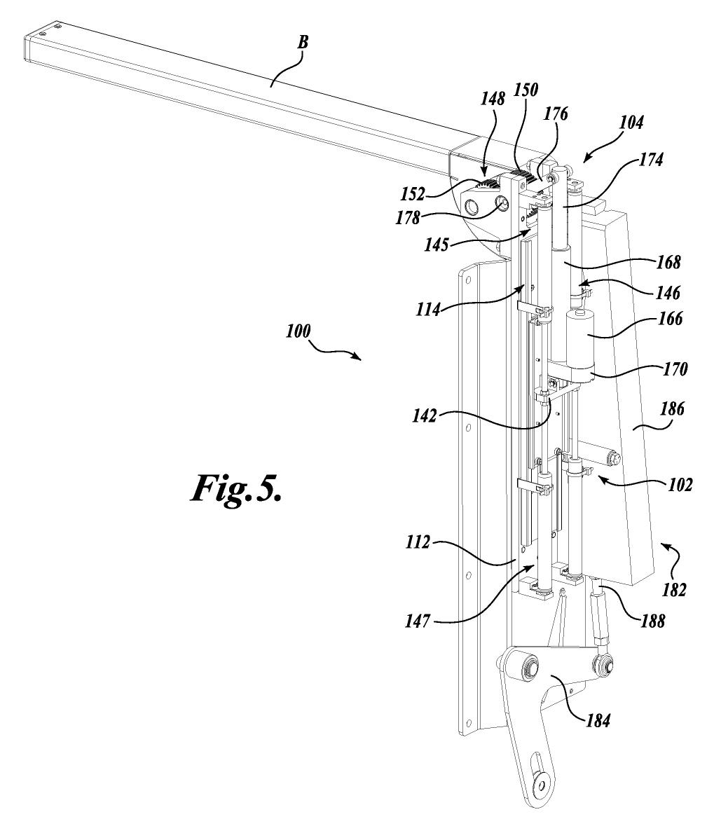

Now referring to FIG. 5, the drive assembly 100 is shown in combination with an arm guard B. The drive shaft 178 of the drive assembly 100 is coupled to the arm guard B to reciprocate or move the arm guard B between at least first and second directions, or between at least an extended and collapsed position. A connecting link 182 is operably coupled to the arm guard B at one end such that the connecting link 182 is reciprocated by the drive assembly 100 along with the arm guard B. The connecting link 182 is driven in a generally vertical direction by the arm guard B through a cam assembly, a linkage, a gear system, or other suitable assembly. The connecting link comprises a counterweight 186 and a turnbuckle 188, with the counterweight 186 operably coupled to the arm guard B and the turnbuckle 188 pivotally coupled to one arm of a bell crank 184.

A ramp barrier C (shown in FIG. 1) is pivotally coupled to the other arm of the bell crank 184 through a linkage, cam assembly, gear system, or other suitable assembly such that the bell crank 184 transmits the motion of the connecting link 182 to the ramp barrier C. Accordingly, the arm guard B and ramp barrier C are simultaneously reciprocated by the drive assembly 100 between extended and collapsed positions. Moreover, the counterweight balances the loads between the arm guard B and ramp barrier C. However, it should be appreciated that the arm guard B and/or ramp barrier C may instead be constructed of lighter materials such that a counterweight would be unnecessary.

To lower the arm guard B, the motor 166 drives the actuator 146 to retract the push rod 174, thereby rotating the first gear 150 clockwise. The first gear 150 drives the second gear 152 in a counterclockwise direction, which in turn drives the drive shaft 178 counterclockwise to lower the arm guard B. As the arm guard B is being lowered, the connecting link 182 is driven in a generally upward direction, and the bell crank 184 is rotated in a counterclockwise direction to lower the ramp barrier C.

If the arm guard B or ramp barrier C encounters an obstruction as they are being lowered, the first gear 150, second gear 152, and push rod 174 slow in movement. The cylinder 168 and carriage 142 are pulled toward the gear system 148 and the first pair of springs 145 compress. As a result, the application of the driving force of the actuator 146 is redirected to the first pair of springs 145, and damage to the obstruction and the actuator is prevented. The actuator 146 shuts off when it is fully retracted.

To raise the arm guard B and ramp barrier C, the push rod 174 is extended to rotate the first gear 150 counterclockwise, and to rotate the second gear 152 and drive axle clockwise. The connecting link 182 is driven in a generally downward direction, rotating the bell crank 184 clockwise to raise the ramp barrier C. If the arm guard B or ramp barrier C encounters an obstruction as they are being raised, the push rod 174 slows or stops, and the cylinder 168 slides away from the gear system 148 along the push rod 174. The cylinder 168 pushes the carriage 142 and causes the second pair of gas springs 147 to compress. The linear actuator 146 will shut off when it is fully extended. It may also be appreciated that the arm guard B and ramp barrier C can be operated independently by separate drive assemblies 100 with no connecting link 182.

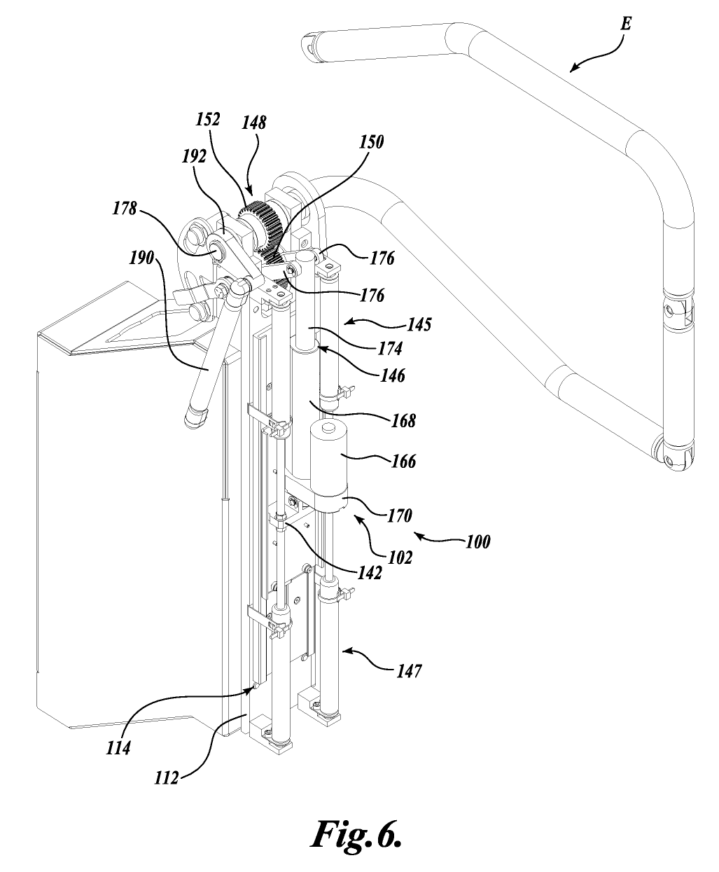

Referring to FIG. 6, the drive assembly 100 is shown in combination with a handrail assembly E in the lowered position. The drive shaft 178 of the drive assembly 100 is coupled to the handrail assembly E to reciprocate the handrail assembly E between a raised and lowered position. An optional gas spring 190 is pivotally coupled to the drive shaft 178 through a yoke or link 192. The gas spring 190 counterbalances the handrail assembly E and reduces the load on the drive assembly 100.

To raise the handrail assembly E, the actuator 146 retracts the pushrod 174 and drives the first gear 150 in a clockwise direction. The first gear 150 drives the second gear 152 and the drive axle 178 in a counterclockwise direction, thereby raising the handrail assembly E. If the handrail assembly E encounters an obstruction as it is being raised, the push rod 174 slows in translation. The cylinder 168 and carriage 142 are pulled toward the gear system 148 and the first pair of springs 145 compress. As a result, application of the driving force of the actuator 146 is redirected to the first pair of springs 145, and damage to the obstruction and the actuator is prevented. The actuator 146 shuts off when it is fully retracted.

To lower the handrail assembly E, the push rod 174 is extended to rotate the first gear 150 counterclockwise, and to rotate the second gear 152 and drive axle 178 clockwise to raise the handrail assembly E. If the handrail assembly E encounters an obstruction as it is being lowered, the push rod 174 slows or stops, and the cylinder 168 slides away from the gear system 148 along the push rod 174. The cylinder 168 pushes the carriage 142 and causes the second pair of gas springs 147 to compress. The linear actuator 146 will shut off when it is fully extended.

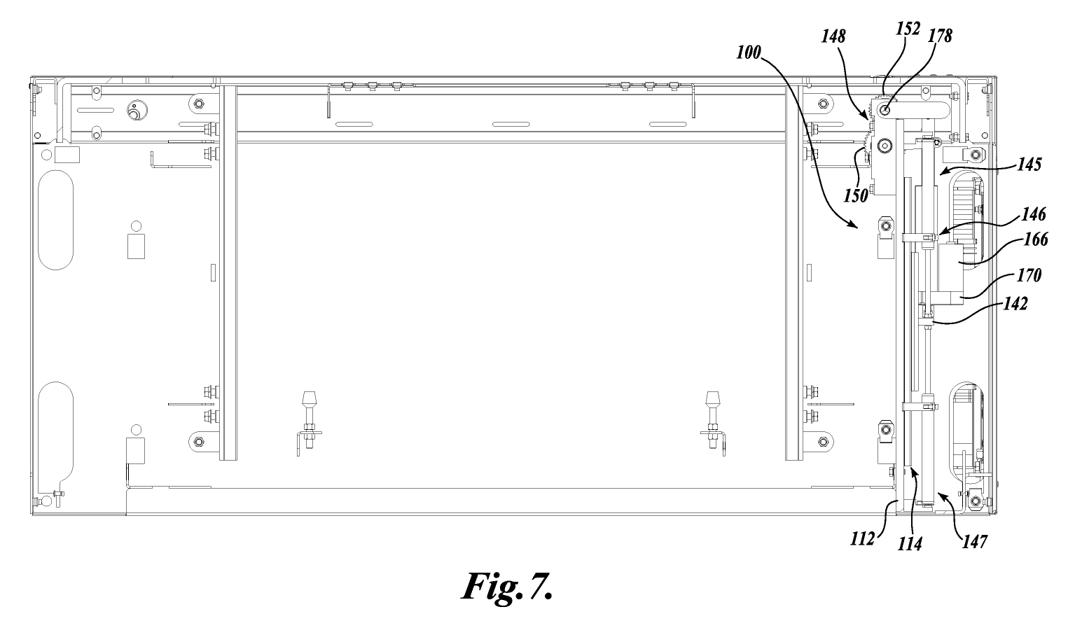

Now referring to FIG. 7, the drive assembly 100 is shown in combination with a barrier gate D. The drive assembly 100 is mounted in any suitable manner beneath the barrier gate D such that the drive axle 178 drives the barrier gate D between first and second directions, i.e. between open and closed.

To close the barrier gate D, the push rod 174 is extended to rotate the first gear 150 counterclockwise and to rotate the second gear 152 and drive axle 178 clockwise to move the barrier gate D toward the wheelchair lift assembly A. If the barrier gate D encounters an obstruction as it is being closed, the push rod 174 slows or stops, and the cylinder 168 slides away from the gear system 148 along the push rod 174. The cylinder 168 pushes the carriage 142 and causes the second pair of gas springs 147 to compress. The linear actuator 146 will shut off when it is fully extended.

To open the barrier gate D, the actuator 146 retracts the push rod 174 and drives the first gear 150 in a clockwise direction. The first gear 150 drives the second gear 152 and the drive axle 178 in a counterclockwise direction, thereby opening the barrier gate D. If the barrier gate D encounters an obstruction as it is being opened, the push rod 174 slows in translation. The cylinder 168 and carriage 142 are pulled toward the gear system 148 and the first pair of springs 145 compress. As a result, the driving movement of the actuator 146 is redirected to the first pair of springs 145, and damage to the obstruction and the actuator is prevented. The actuator 146 shuts off when it is fully retracted.

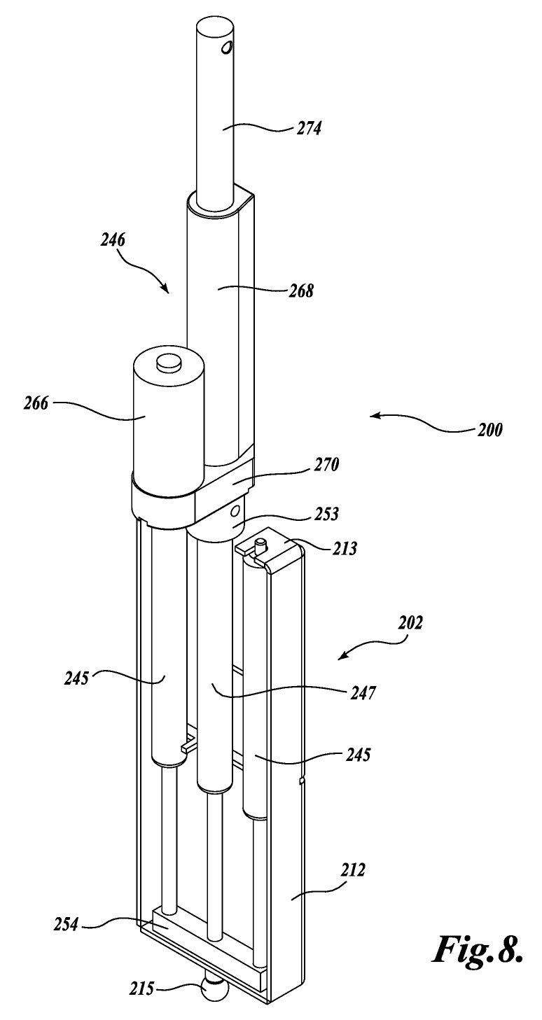

FIG. 8 depicts an alternate embodiment of the drive assembly 200, with the materials, operation, and uses of the drive assembly 200 illustrated in conjunction with the above described components. Although the above drive assembly 100 is described in great detail and shown in combination with the actuatable components B-E, the drive assembly 200 is the preferred embodiment. The drive assembly 200 includes an overload assembly 202 having a gas spring housing 212 with a middle gas spring 247 and two lateral gas springs 245 disposed therewithin. The gas spring housing 212 may be any suitable shape such that it provides the appropriate compression surfaces for the gas springs 245 and 247. The cylinder end of the middle gas spring 247 protrudes through an opening in the gas spring housing 212 and is mounted to a mounting portion 253 of an actuator base 270. The rod end of the middle gas spring 247 is coupled to a compression bar 254 disposed within the bottom of the gas spring housing 212. The rod ends of the lateral gas springs 245 are coupled to the compression bar 254, and the cylinder ends of the lateral gas springs 245 are coupled in compression to an upper housing edge 213 of the gas spring housing 212 opposite the compression bar 254.

The drive assembly 200 includes a motor 266 and a linear actuator 246 secured to the actuator base 270, and the push rod 274 of the linear actuator 246 is operably coupled to a gear system or linkage (not shown) of the actuatable component. The drive assembly 200 may be pivotally coupled to the wheelchair lift assembly A via a pivotal attachment 215 extending outwardly from the bottom surface of the housing 212.

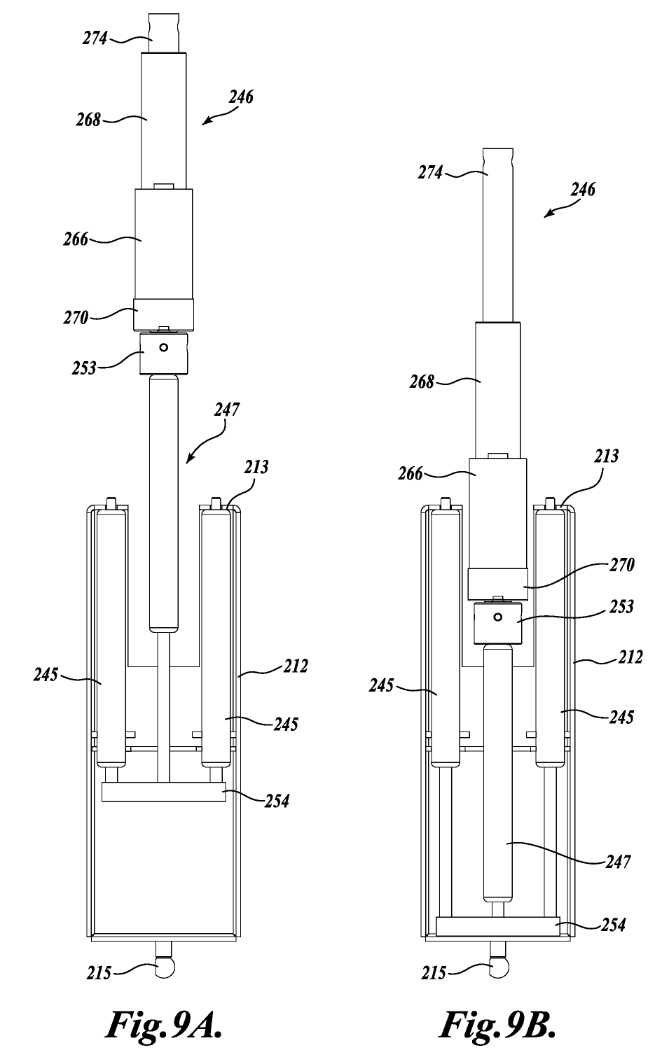

Similar to the overload assembly 102, the overload assembly 202 protects the actuator and obstruction when an actuatable component engages an obstruction. As best seen by referring to FIG. 9A, when the push rod 274 is retracting to move the actuatable component and the actuatable component encounters an obstruction, the obstruction causes the gear system (not shown) and push rod 274 to slow or stop. The actuator 246 continues to retract; however, application of the driving force is redirected and the cylinder 268 is instead pulled toward the gear system along the push rod 274. As a result, the actuator cylinder 268, actuator base 270, the middle gas spring 247, and the compression bar 254 are simultaneously pulled upward, and the compression bar 254 exerts a force on the rods of the lateral gas springs 245. Once the force exceeds the preset load of the lateral gas springs 245, the lateral gas springs 245 compress against the housing edge 213. As the lateral gas springs 245 continue to compress, the driving force of the linear actuator 246 on the component is limited by the spring rate of the lateral gas springs 245. Moreover, the linear actuator 246 shuts off when it is fully retracted.

Referring to FIG. 9B, if the push rod 274 is extending to move the actuatable component and the component encounters an obstruction, the push rod 274 slows or stops. The actuator 246 continues to extend, and the cylinder of the middle gas spring 247 is pushed away from the gear system along the push rod 274. As a result, application of the driving force is redirected to the rod of the middle gas spring 247. Once the force exceeds the preset load in the middle gas spring 247, the middle gas spring 247 compresses against the compression bar 254. As the middle gas spring 247 compresses, the driving force of the actuator 246 on the component is limited by the characteristic of the middle gas spring 247. The linear actuator 246 shuts off when the actuator is fully extended.

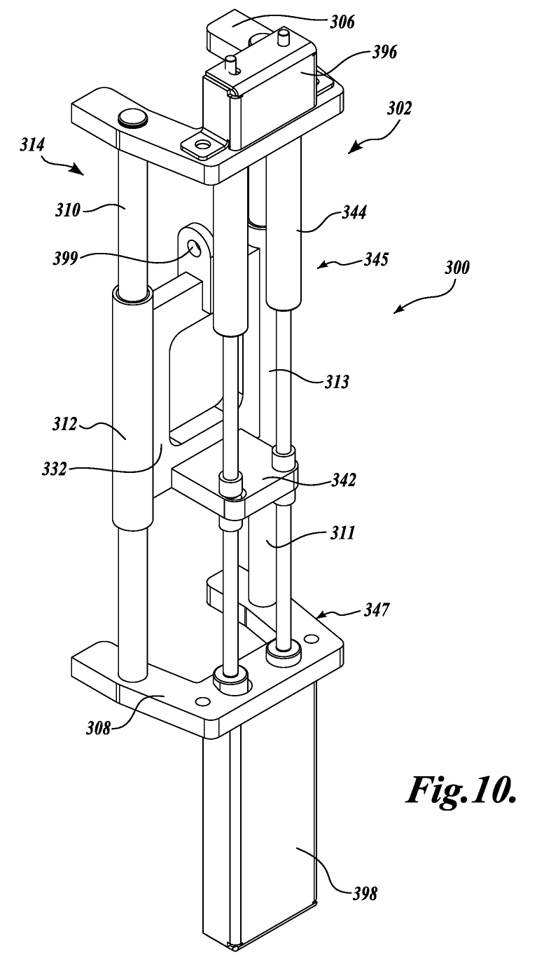

Now referring to FIG. 10, another embodiment of the drive assembly 300 includes an overload assembly 302 having a frame defined by a first plate 306 and a second plate 308 that are both preferably U-shaped but may be any suitable shape. First and second housing members 396 and 398 are coupled to the exterior of the first and second plates 306 and 308 for receiving and retaining the cylinder ends of gas springs 344. The first and second plates 306 and 308 are coupled together by first and second rods 310 and 311. First and second sleeve bearings 312 and 313 are slidably received on the first and second rods 310 and 311 and are interconnected by a slidable support 332 to cooperatively form a linear slide 314. The overload assembly 302 further includes a carriage 342 mounted on the slidable support 332. A linear actuator (not shown) may be pivotally coupled to the slidable support 332 at pin hole 399 with a pin or other fastener.

A plurality of gas springs 344 are disposed between the first and second housing members 396 and 398 and the carriage 342. A first pair of preloaded gas springs 345 are in compression contact with the carriage 342 at the rod ends of the gas springs 345 and are received within the first housing member 396 at the cylinder ends of the gas springs 345. A second pair of preloaded gas springs 347 opposing the first pair are in compression contact with the carriage 342 at the rod ends of the gas springs 347 and are received within the second housing member 398 at the cylinder ends of the gas springs 347.

The overload assembly 302 operates in a similar fashion to the overload assembly 102. In other words, when an actuatable component encounters an obstruction while the component is being actuated, application of the driving force is redirected to one pair of gas springs 345 or 347 that will compress after the preset load is exceeded to allow the actuator to continue extending or retracting. The actuator cylinder and carriage 342 will slide with the sleeve bearings 312 when the springs 345 or 347 compress. The actuator is allowed to fully extend or retract before the limit switch shuts the actuator off. Thus, damage to the actuator or obstruction is prevented.

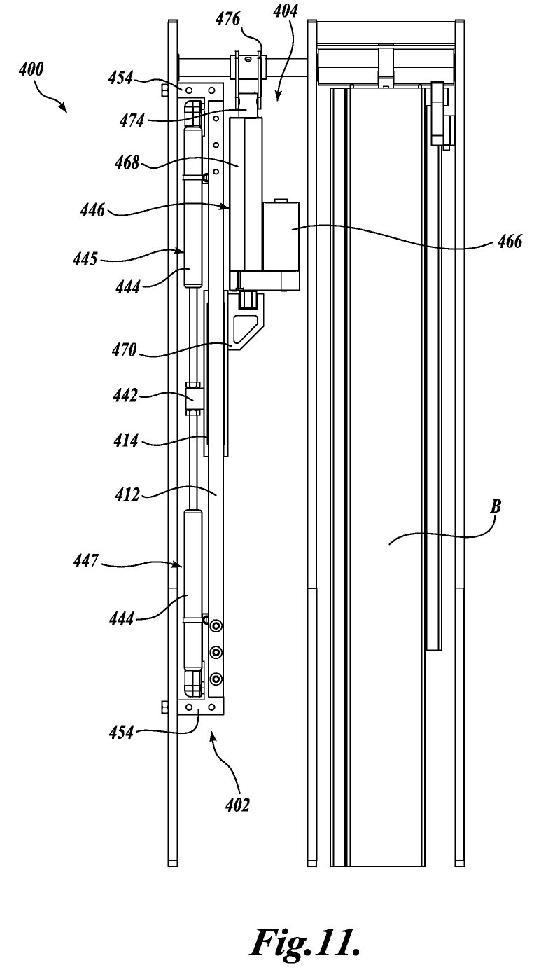

FIG. 11 depicts still yet another embodiment of the drive assembly 400. The drive assembly 400 includes an overload assembly 402 having a frame defined by two longitudinal base rods 412 spaced apart in a parallel relationship and coupled together at their ends by end blocks 454. A linear slide 414 is slidably disposed between the longitudinal base rods 412. A carriage 442 is coupled to one side of the linear slide 414, and an actuator mounting piece 470 is coupled to the other side of the linear slide 414. The actuating assembly 404 includes a linear actuator 446 coupled to the actuator mounting piece 470 at one end and coupled to the actuatable component at the other end. First and second preloaded gas springs 445 and 447 oppose one another with the cylinder ends being coupled to the end blocks 454 and the rod ends in compression contact with the carriage 442 to maintain the carriage 442 and linear actuator 446 in a neutral position.

The overload assembly 402 operates in a similar fashion to the overload assembly 102. In other words, when an actuatable component (such as an arm guard) encounters an obstruction while the component is being actuated, one gas spring 445 or 447 will compress after the preset load is exceeded to redirect application of the driving force and allow the actuator 446 to continue extending or retracting. The actuator cylinder 468 and carriage 442 will slide with the linear slide 414 when a spring 444 compresses. The actuator 446 is allowed to fully extend or retract before the limit switch shuts the actuator off. Thus, damage to the actuator or obstruction is prevented.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A drive assembly for a wheelchair lift, the drive assembly comprising:
(a) an actuating assembly in communication with a component of the wheelchair lift and configured to selectively apply a driving force to move the component between at least first and second positions; and
(b) an overload assembly coupled to the actuating assembly and configured to redirect application of the driving force from the component to the overload assembly when a force applied to the component exceeds a predetermined limit.

2. The drive assembly of claim 1, wherein the overload assembly has first and second override mechanisms.

3. The drive assembly of claim 2, wherein the first and second override mechanisms cooperatively maintain the actuating assembly in a substantially neutral position when the driving force is less than or equal to the predetermined limit.

4. The drive assembly of claim 2, wherein the first override mechanism has a first stroke length and the second override mechanism has a second stroke length.

5. The drive assembly of claim 2, wherein the first override mechanism has a first predetermined spring rate and the second override mechanism has a second predetermined spring rate.

6. The drive assembly of claim 5, wherein the driving force is limited by the predetermined spring rate of either the first or second override mechanism.

7. The drive assembly of claim 5, wherein the first and second predetermined spring rates are substantially equal.

8. The drive assembly of claim 1, wherein at least a portion of the overload assembly moves in a first direction when application of the driving force is redirected from the component to the overload assembly.

9. A drive assembly for a wheelchair lift, the drive assembly comprising:
(a) an actuating assembly in communication with a component of the wheelchair lift and configured to selectively apply a driving force to move the component between at least first and second positions;
(b) at least first and second override mechanisms in communication with the actuating assembly, the first override mechanism adapted to redirect application of the driving force in a first direction when a first force applied to the component exceeds a first predetermined limit, and the second override mechanism adapted to redirect application of the driving force in a second direction when a second force applied to the component exceeds a second predetermined limit.

10. The drive assembly of claim 9, wherein the actuating assembly is moveably coupled to a frame.

11. The drive assembly of claim 9, wherein the first predetermined limit is substantially equal in magnitude to the second predetermined limit.

12. The drive assembly of claim 9, wherein the first override mechanism has a first predetermined spring rate and the second override mechanism has a second predetermined spring rate.

13. The drive assembly of claim 12, wherein the driving force is limited by the predetermined spring rate of either the first or second override mechanism.

14. The drive assembly of claim 9, wherein the first override mechanism opposes the second override mechanism such that the first and second override mechanisms cooperatively maintain the actuating assembly in a substantially neutral position when the driving force is less than or equal to a predetermined limit.

15. The drive assembly of claim 9, wherein the first override mechanism has a first preset load and the second override mechanism has a second preset load.

16. The drive assembly of claim 15, wherein the first predetermined limit is equal to the first preset load and the second predetermined limit is equal to the second preset load.

17. A drive assembly for a wheelchair lift, the drive assembly comprising:
(a) an actuating assembly in communication with a component of the wheelchair lift and configured to selectively apply a driving force to move the component between at least first and second directions; and
(b) an overload assembly having first and second override mechanisms coupled to the actuating assembly and configured to redirect movement of the component to the first or second override mechanism when a force applied to the component exceeds a predetermined limit.

18. The drive assembly of claim 17, wherein the first and second override mechanisms cooperatively maintain the actuating assembly in a substantially neutral position when the driving force is less than or equal to the predetermined limit.

19. The drive assembly of claim 17, wherein the first override mechanism has a first stroke length and the second override mechanism has a second stroke length.

20. The drive assembly of claim 17, wherein the first override mechanism has a first predetermined spring rate and the second override mechanism has a second predetermined spring rate.

21. The drive assembly of claim 20, wherein the driving force is limited by the spring rate of either the first or second override mechanism.
